(19) United States
(12) Patent Application Publication
(10) Pub. No.: US 2007/0019521 A1
(43) Pub. Date: Jan. 25, 2007

(54) Method and apparatus for flexibly setting channels of multi-channel audio data

(75) Inventors: Seung-hoon Kim, Seoul (KR); Chang-yong Heo, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/491,273

(22) Filed: Jul. 24, 2006

(30) Foreign Application Priority Data
Jul. 23, 2005 (KR) 10-2005-0067079

(51) Int. Cl. G11B 5/09

(52) U.S. Cl. 369/47.16

(57) ABSTRACT

An audio system apparatus and method for processing multi-channel audio data are provided. In the audio system, information indicating a correspondence relation between the channels of the multi-channel audio data and speakers installed in an arbitrary space is generated based on selection by a user, and according to the generated information, the channels of the multi-channel audio data are rearranged. By doing so, terminals of the output panel of the audio system and speakers can be connected arbitrarily according to convenience of a user and channels of multi-channel audio data can be set appropriately to the connection status.

### CROSS-REFERENCE TO RELATED PATENT APPLICATIONS

This application claims priority from Korean Patent Application No. 10-2005-0067079, filed on Jul. 23, 2005, in the Korean Intellectual Property Office, the disclosure of which is incorporated herein in its entirety by reference.

### BACKGROUND OF THE INVENTION

1. Field of the Invention

Apparatuses and methods consistent with the present invention relate to an audio system, and more particularly, to an audio system for processing multi-channel audio data.

2. Description of the Related Art

FIG. 1 is a diagram of the structure of a related art audio system.

Referring to FIG. 1, the related art audio system includes a decoder 11, a memory 12, a direct memory access (DMA) control unit 13, an audio input/output (I/O) unit 14, and a digital/analog (D/A) converter 15.

The decoder 11 decodes an audio stream according to an audio format standard identical to the audio format standard used by an audio content provider side. As representative audio format standards, there are advanced audio coding (AAC), and audio coding number 3 (AC-3).

The memory 12 stores audio data that is the result of the decoding by the decoder 11. Generally, the audio data is pulse code modulation (PCM) data.

The DMA control unit 13 reads audio data from the memory 12 in a DMA method and outputs the audio data to the audio I/O unit 14.

The audio I/O unit 14 extracts each channel of the audio data input from the DMA control unit 13 and outputs the audio data in the form of multi-channel audio data.

The D/A converter 15 converts the multi-channel audio data input from the audio I/O unit 14 into analog multi-channel audio data and outputs this analog signal to a speaker connected to the audio system.

FIG. 2 is a diagram of the structure of the related art I/O unit 15.

Referring to FIG. 2, the related art audio I/O unit 15 includes an audio I/O control unit 21, a buffer 22, and a data extraction unit 23.

Based on address, data, and control signals input from the DMA control unit 14 the audio I/O control unit 21 outputs audio data to the buffer 22 so that the audio data can be divided into respective channels and stored separately.

The buffer 22 stores each channel of the audio data input from the audio I/O control unit 21, in an area corresponding to the channel.

The data extraction unit 23 extracts serial audio data divided into each channel from the audio data stored in the respective channel areas of the buffer 22.

According to an inter-IC sound (12S) method that is widely used in general, when a word selection signal is in a logic high level, audio data corresponding to an R channel is extracted, and when in a logic low level, audio data corresponding to an L channel is extracted. If three word selection signals are processed concurrently, 6-channel audio data can be extracted.

The multi-channel audio data extracted by the data extraction unit 23 passes through the D/A converter 411 and is finally output through terminals of the output panel 24 of the audio system. If the multi-channel audio data is 6-channel audio data, the data is output through six terminals of the output panel 24 of the audio system.

Thus, in the related art audio system, audio data is stored in each channel area of the buffer 22 according to the DMA method, and this audio data is output through the terminals of the output panel 24 of the audio system in the form of serial audio data divided into each channel. Accordingly, after a user installs the speakers in an arbitrary space, the user should connect speakers that are appropriate to channels of the terminals, to the terminals of the output panel 24 of the audio system.

If the terminals of the output panel 24 of the audio system are incorrectly connected to the speakers, in case of a 2-channel audio system, the user can reconnect the terminals without much inconvenience. However, as the number of channels increases, correctly reconnecting the terminals becomes much more difficult. For example, in case of the 6-channel audio system, terminals corresponding to an L channel, an R channel, an Ls channel, an Rs channel, a C channel, and an Lfe channel, respectively, should be accurately connected to corresponding speakers. If any one of the terminals is incorrectly connected, all terminals and speakers will require considerable effort in order to be reconnected correctly.

### SUMMARY OF THE INVENTION

Apparatuses and methods consistent with the present invention relate to conveniently connecting terminals of an output panel of an audio system reproducing multi-channel audio data to speakers.

The present invention also provides a computer-readable recording medium having embodied thereon a computer program for executing the method.

According to an aspect of the present invention, there is provided a method of flexibly setting channels of multi-channel audio data including: based on selection by a user, generating information indicating a correspondence relation between the channels of the multi-channel audio data and speakers installed in an arbitrary space; and according to the generated information, rearranging the channels of the multi-channel audio data.

According to another aspect of the present invention, there is provided an apparatus for flexibly setting channels of multi-channel audio data including: a user interface which generates information indicating a correspondence relation between the channels of the multi-channel audio data and speakers installed in an arbitrary space based on selection by a user; and a channel rearrangement unit which rearranges the channels of the multi-channel audio data according to the generated information.

According to still another aspect of the present invention, there is provided a computer readable recording medium having embodied thereon a computer program for executing the method.

### BRIEF DESCRIPTION OF THE DRAWINGS

The above and other aspects of the present invention will become more apparent by describing in detail exemplary embodiments thereof with reference to the attached drawings in which:

FIG. 1 is a diagram of the structure of the related audio system;

FIG. 2 is a diagram of the structure of the related I/O unit;

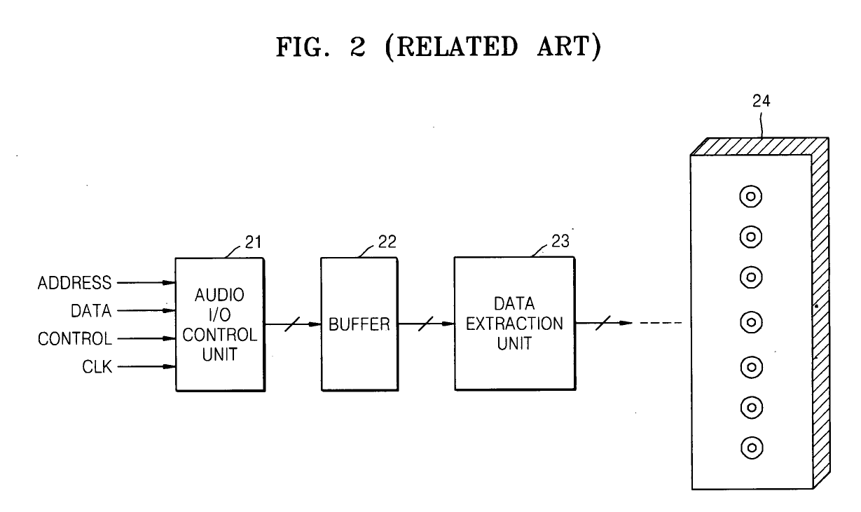

FIG. 3 is a diagram of the structure of a channel setting apparatus according to an exemplary embodiment of the present invention;

FIG. 4 is a detailed diagram of the structure of a channel rearrangement unit shown in FIG. 4;

FIG. 5 is a diagram of the structure of an audio I/O unit according to an exemplary embodiment of the present invention;

FIG. 6 is a diagram of the structure of an audio I/O unit according to another exemplary embodiment of the present invention;

FIG. 7 is a diagram of the structure of an audio system according to an exemplary embodiment of the present invention;

FIG. 8 is a flowchart of a channel setting method according to an exemplary embodiment of the present invention; and

FIG. 9 is a flowchart of a channel setting method following the channel setting method shown in FIG. 8.

### DETAILED DESCRIPTION OF THE INVENTION

The present invention will now be described more fully with reference to the accompanying drawings, in which exemplary embodiments of the invention are shown.

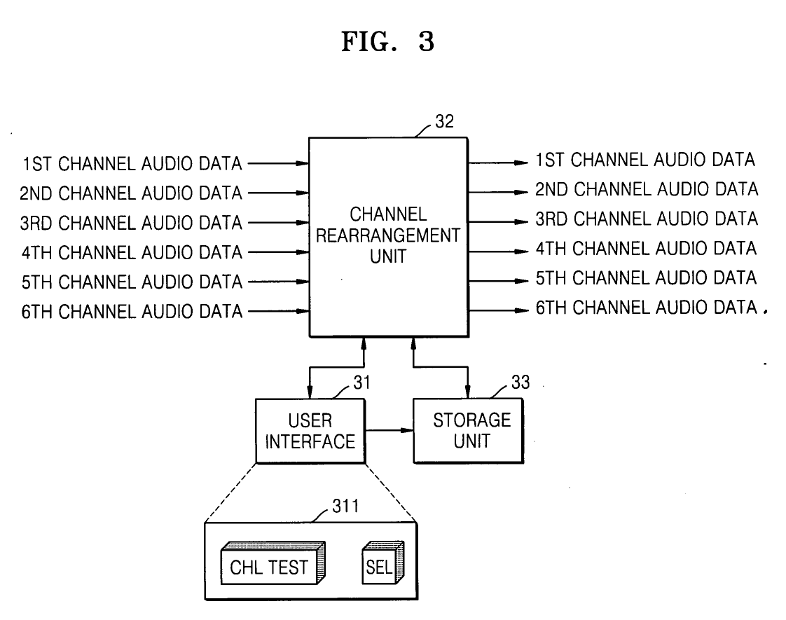

Referring to FIG. 3, the channel setting apparatus according to an exemplary embodiment of the present invention includes a user interface 31, a channel rearrangement unit 32 and a storage unit 33.

Based on selection of a user, the user interface 31 generates channel setting information indicating the correspondence relation between channels of multi-channel audio data and speakers installed in an arbitrary space.

More specifically, the user interface 31 extracts audio data corresponding to one channel in the multi-channel audio data, and controls this audio data so that this audio data is output sequentially to the speakers installed in the arbitrary space, and based on the selection of the user who recognizes the output of this audio data, generates channel setting information on this audio data.

By manipulating keys on the input panel 311 shown in FIG. 3, the user can set the correspondence relation between the channels of the multi-channel audio data and the speakers as follows. First, the user pushes a channel test key. If a first channel is an R channel, sound “right” is output sequentially from the speakers installed in the space. When the sound “right” is output from a speaker that is desired to be set as an R channel by the user, the user pushes a selection key. According to this key input, a correspondence relation between the R channel of the multi-channel audio data and any one of the speakers installed in the space is set. Then, if a second channel is an L channel, sound “left” is output sequentially from the speakers installed in the space. This process is repeated for all channels of the multi-channel audio data.

The input panel 311 described above can be implemented in a variety of ways, including an input apparatus of an audio system, an input apparatus of a remote controller, and an on screen display (OSD) method. In particular, those skilled in the art of the present invention can easily design, based on the above explanation, an input panel in a form other than the input panel 311 shown in FIG. 3.

The channel rearrangement unit 32 rearranges channel of the multi-channel audio data according to the information generated by the user interface 31.

More specifically, by setting the channels of the multi-channel audio data as the channels allocated to speakers, which are selected by the user as corresponding to the channels of the multi-channel audio data, the channel rearrangement unit 32 rearranges the channels of the multi-channel audio data.

The storage unit 33 stores the channel setting information generated by the user interface 31. Also, if already set channel setting information is stored in the storage unit 33, the rearrangement unit 32 rearranges the channels of the multi-channel audio data according to the information stored in the storage unit 33.

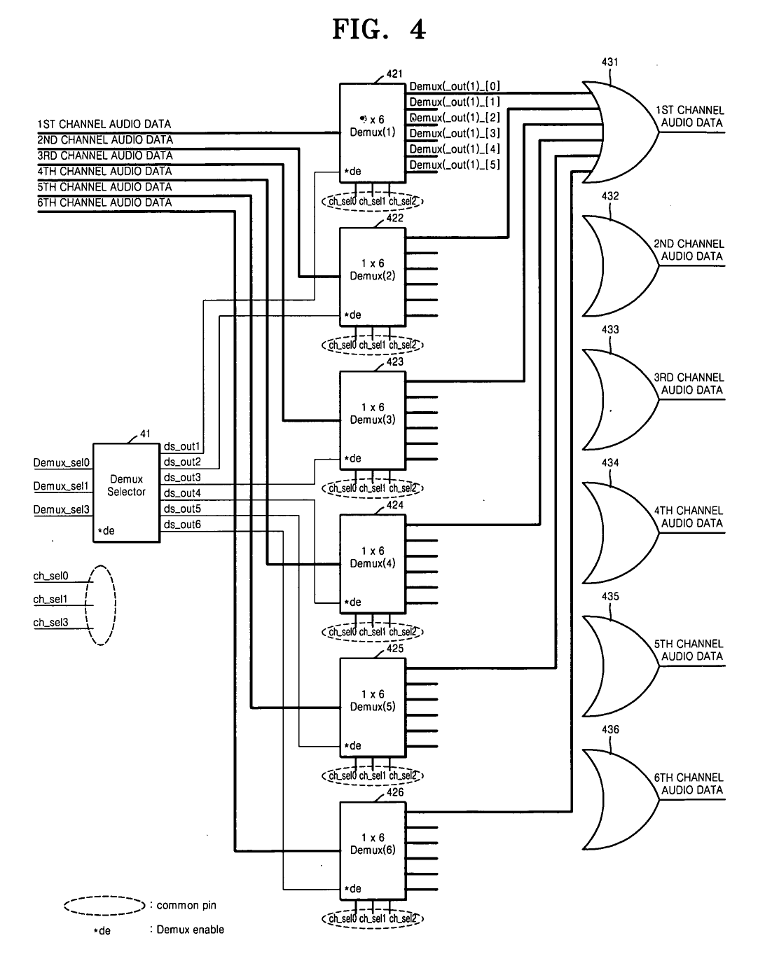

FIG. 4 is a detailed diagram of the structure of the channel rearrangement unit 32 shown in FIG. 4.

Referring to FIG. 4, the channel rearrangement unit 32 shown in FIG. 3 includes a demux selection unit 41, a first demux 421, a second demux 422, a third demux 423, a fourth demux 424, a fifth demux 425, a sixth demux 426, a first OR gate 431, a second OR gate 432, a third OR gate 433, a fourth OR gate 434, a fifth OR gate 435, and a sixth OR gate 436. The channel rearrangement unit 32 shown in FIG. 3 relates to 6-channel audio data. Those skilled in the art of the present exemplary embodiment can easily design a channel rearrangement unit for audio data having other numbers of channels of audio data, such as 7-channel audio data and 8-channel audio data, based on the channel rearrangement unit 32 shown in FIG. 3.

The user interface 31 outputs the channel setting information generated as described above, in the form of demux selection signals, demux_sel0, demux_sel1, and demux_sel2, and channel selection signals, ch_sel0, ch_sel1, and ch_sel2.

For example, in order for the audio data input to the first channel to be output to the sixth channel, the user interface 31 should output a signal for selecting the first demux 421 and the sixth channel. That is, the user interface 31 should output demux_sel0=0, demux_sel1=0, demux_sel2=0, ch_sel0=1, ch_sel1=1, and ch_sel2=1.

The demux selection unit 41 enables only one among the six demuxes 421 through 426 according to the value of the demux selection signal demux_sel0, demux_sel1, and demux_sel2, input from the user interface 31. That is, the demux selection unit 41 performs a role for extracting audio data corresponding to one channel of the 6-channel audio data.

The demux enabled by the demux selection unit 41 among the first through sixth demuxes 421 through 426 outputs audio data corresponding to any one channel according to the value of the channel selection signals ch_sel0, ch_sel1, and ch_sel2 input from the user interface 31, through any one line enabled by the demux selection unit 41, of six output lines. That is, the first through sixth demuxes 421 through 426 perform roles for setting the audio data channel selected by the demux selection unit 41, as a channel allocated to a speaker selected by the user as corresponding to this audio channel. If audio data corresponding to any one channel is output from at least one or more demuxes among the first through sixth demuxes 421 through 426, a first OR gate 431, a second OR gate 432, a third OR gate 433, a fourth OR gate 434, a fifth OR gate 435, and a sixth OR gate 436 perform OR operations with the audio data. These OR operations perform a role of unifying total 36 output lines of the first through sixth demuxes 421 through 426 into total 6 output lines.

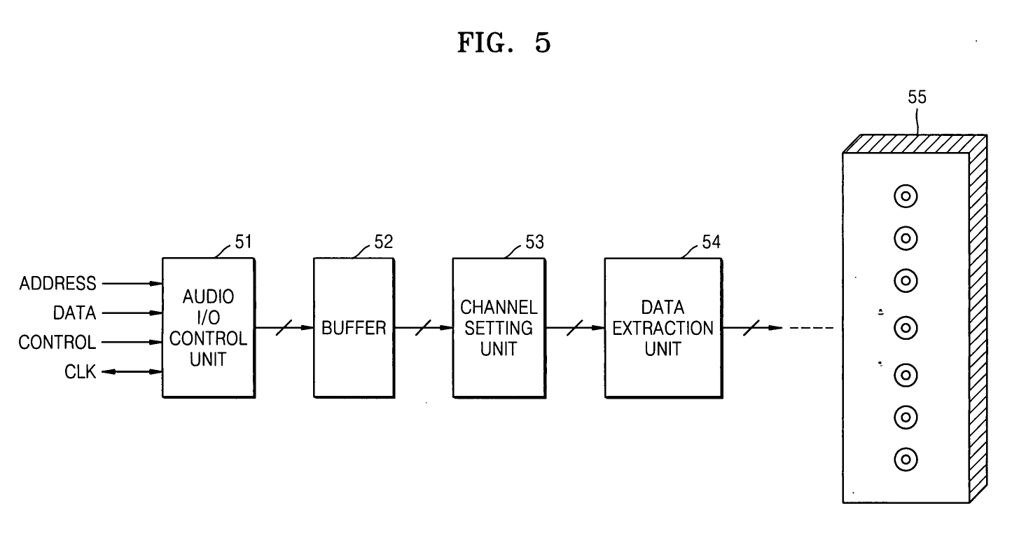

FIG. 5 is a diagram of the structure of an audio I/O unit according to an exemplary embodiment of the present invention.

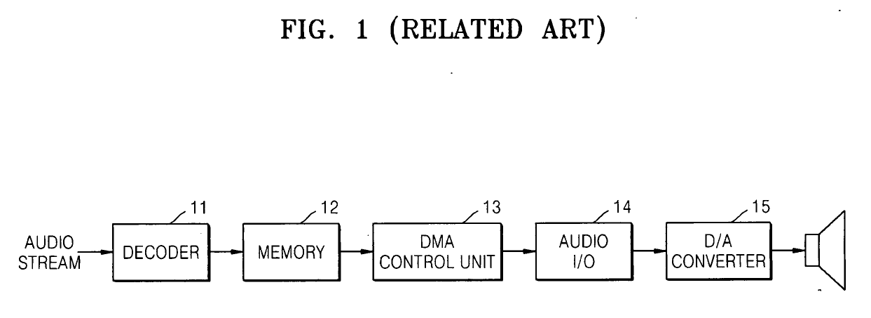

Referring to FIG. 5, the audio I/O unit according to the exemplary embodiment of the present invention is constructed by adding the channel setting apparatus shown in FIG. 4 after the buffer 52 of the related art audio I/O unit 15 shown in FIG. 1, and includes an audio I/O control unit 51, a buffer 52, a channel setting unit 53, and a data extraction unit 54.

Based on address, data and control signals input from a DMA control unit, the audio I/O control unit 51 outputs audio data to the buffer 52 so that the audio data can be divided into respective channels and stored separately.

The buffer 52 stores each channel of the audio data input from the audio I/O control unit 51, in an area corresponding to the channel.

Based on selection by a user, the channel setting unit 53 generates information indicating the correspondence relations between the channels of the multi-channel audio data stored in the respective channel areas of the buffer 52 and speakers installed in the arbitrary space, and according to this information, rearranges the channels of the multi-channel audio data. That is, the multi-channel audio data input to the channel setting unit 53 is the multi-channel audio data stored in the respective channel areas of the buffer 52.

The data extraction unit 54 extracts serial audio data divided into separate channels from the multi-channel audio data having the channels rearranged by the channel setting unit 54.

The multi-channel audio data extracted by the data extraction unit 54 passes through a D/A converter and is finally output through terminals of the output panel 55 of the audio system.

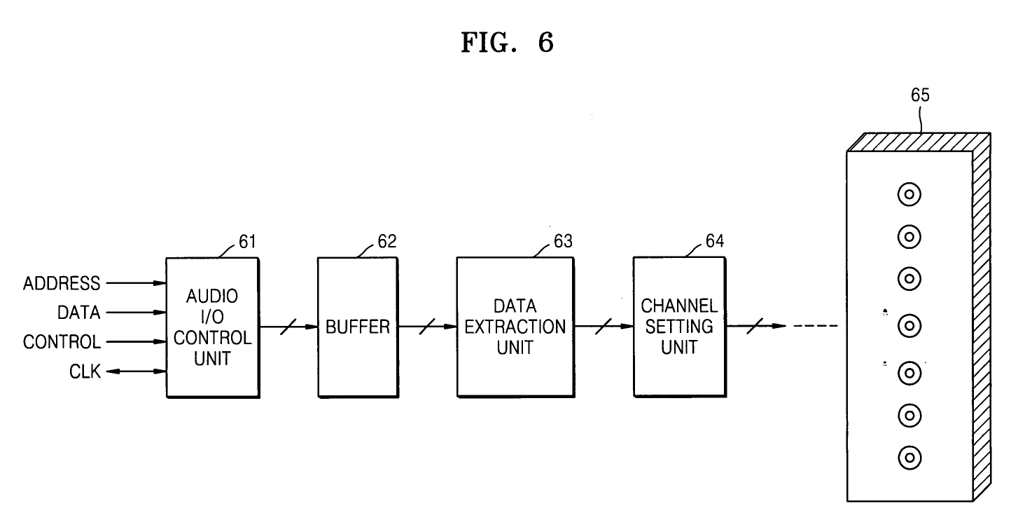

FIG. 6 is a diagram of the structure of an audio I/O unit according to another exemplary embodiment of the present invention.

Referring to FIG. 6, the I/O unit according to the other exemplary embodiment is constructed by adding the channel setting apparatus shown in FIG. 4 after the data extraction unit 63 of the related art audio I/O unit 15 shown in FIG. 1, and includes an audio I/O control unit 61, a buffer 62, a data extraction unit 63 and a channel setting unit 64.

Based on address, data and control signals input from a DMA control unit, the audio I/O control unit 61 outputs audio data to the buffer 62 so that the audio data can be divided into respective channels and stored separately.

The buffer 62 stores each channel of the audio data input from the audio I/O control unit 61, in an area corresponding to the channel.

The data extraction unit 63 extracts serial audio data, that is, multi-channel audio data, divided into separate channels from the audio data stored in the respective channel areas of the buffer 62.

Based on selection by a user, the channel setting unit 64 generates information indicating the correspondence relations between the channels of the multi-channel audio data extracted by the data extraction unit 63 and speakers installed in the arbitrary space, and according to this information, rearranges the channels of the multi-channel audio data. That is, the multi-channel audio data input to the channel setting unit 64 is the serial audio data divided into separate channels.

The multi-channel audio data having channels rearranged by the channel setting unit 64 passes through a D/A converter and is finally output through terminals of the output panel 65 of the audio system.

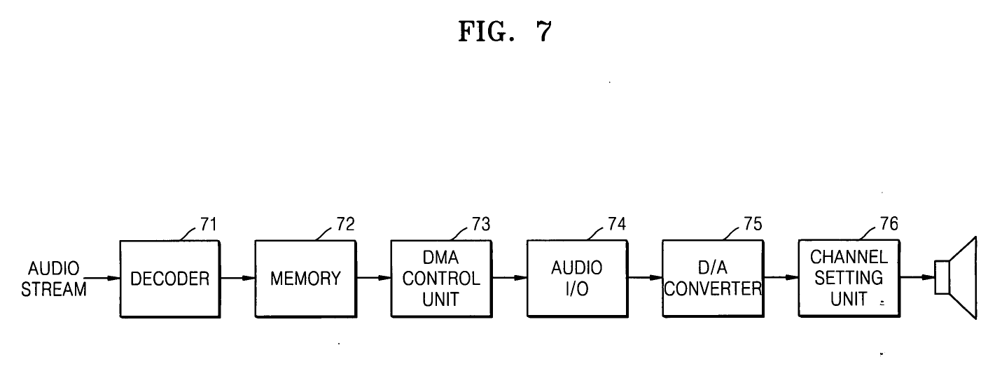

FIG. 7 is a diagram of the structure of an audio system according to an exemplary embodiment of the present invention.

Referring to FIG. 7, the audio system according to the present exemplary embodiment includes a decoder 71, a memory 72, a DMA control unit 73, an audio I/O unit 74, a D/A converter 75, and a channel setting unit 76.

The decoder 71 decodes an audio stream according to an audio format standard identical to the audio format standard used by an audio content provider side.

The memory 72 stores audio data that is the result of the decoding by the decoder 71.

The DMA control unit 73 reads audio data from the memory 72 in a DMA method and outputs the audio data to the audio I/O unit 74.

The audio I/O unit 74 extracts each channel of the audio data input from the DMA control unit 73 and outputs the audio data in the form of multi-channel audio data.

The D/A converter 75 converts the multi-channel audio data input from the audio I/O unit 74 into analog multi-channel audio data.

Based on a selection by a user, the channel setting unit 76 generates information indicating the correspondence relations between the channels of the analog multi-channel audio data that is the result of the conversion in the D/A converter 75, and speakers installed in an arbitrary space, and according to this information, rearranges the channels of the analog multi-channel audio data and outputs the rearranged channels to the speakers connected to the audio system. That is, the multi-channel audio data input to the channel setting unit 76 is analog multi-channel audio data.

Based on the above description, those skilled in the art to which the exemplary embodiments shown in FIGS. 5 through 7 belong can easily insert the channel setting apparatus shown in FIG. 3 between elements different from the exemplary embodiments of FIGS. 5 through 7.

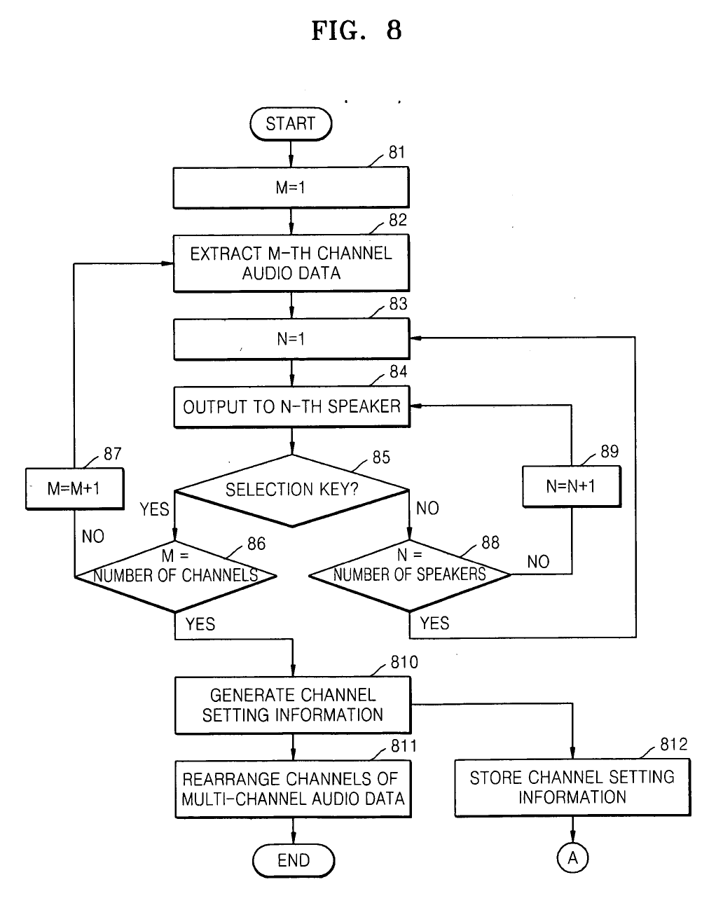

FIG. 8 is a flowchart of a channel setting method according to an exemplary embodiment of the present invention.

Referring to FIG. 8, the channel setting method according to the present exemplary embodiment includes the following operations. The operations forming the channel setting method are processed in a series of time in the channel setting apparatus shown in FIGS. 3 and 4. Accordingly, though omitted in the following explanation, those described above in relation to the channel setting apparatus shown in FIGS. 3 and 4 are applied to a content decoding method according to the present exemplary embodiment.

In operation 81, the channel setting apparatus sets M, a value indicating the number of channels of multi-channel audio data, equal to 1. This means that the values of the demux selection signals, demux_sel0, demux_sel1, and demux_sel2, are output as 0, 0, and 0, respectively.

In operation 82, the channel setting apparatus extracts first channel audio data from the multi-channel audio data. This means that the demux selection unit 41 enables the first demux 421 according to the demux selection signal value.

In operation 83, the channel setting apparatus sets N, a value indicating the number of speakers installed in an arbitrary space, equal to 1. This means that the user interface 31 outputs the values of the channel selection signals, ch_sel0, ch_sel1, and ch_sel2, as 0, 0, and 0, respectively.

In operation 84, the channel setting apparatus outputs the first channel audio data extracted in the operation 82, to the first speaker. This means that the first demux 421 enabled by the demux selection unit 41 outputs the first channel audio data through the first output line among the 6 output lines of the first demux 421 according to the channel selection signal value.

In operation 85, the channel setting apparatus determines whether or not a selection key is input by the user who recognizes the output in the operation 84.

If it is determined in the operation 85 that there is a selection key input, the channel setting apparatus determines whether or not M arrives at the number of channels of the multi-channel audio data in operation 86.

If it is determined in the operation 86 that M does not arrive at the number of the channels of the multi-channel audio data, M is incremented by 1 in operation 87 and the operation 82 is performed again. This means that the user interface 31 outputs the values of the demux selection signals, demux_sel0, demux_sel1, and demux_sel2, as 0, 0, and 1, respectively. After that, while M=2, that is, with respect to the second channel audio data, the process from the operation 82 is repeated.

If it is determined in the operation 85 that there is no selection key input, the channel setting apparatus determines whether or not N arrives at the number of the speakers in operation 88.

If it is determined in the operation 88 that N does not arrive at the number of the speakers, the channel setting apparatus increases N by 1 in operation 89 and performs the operation 84 again. This means that the user interface 31 outputs the values of the channel selection signals, ch_sel0, ch_sel1, and ch_sel2, as 0, 0, and 1, respectively. After that, while N=2, that is, with respect to the second speaker, the process from the operation 84 is repeated.

If it is determined in the operation 88 that N does arrive at the number of the speakers, the channel setting apparatus performs the operation 83 again. This means that though the first channel audio data is output to all speakers, if the user does not input a selection key, the operation 83 is performed again in order to try once more to set a channel of the first channel audio data.

If it is determined in the operation that M arrives at the number of the channels of the multi-channel audio data, that is, if the correspondence relations between all the channels of the multi-channel audio data and the speakers installed in the arbitrary space are formed, the channel setting apparatus generates channel setting information indicating the correspondence relations between the channels of the multi-channel audio data and the speakers installed in the arbitrary space in operation 810.

In operation 811, the channel setting apparatus rearranges the channels of the multi-channel audio data according to the channel setting information generated in the operation 810. More specifically, by setting the channels of the multi-channel audio data as the channels allocated to speakers, which are selected by the user as corresponding to the channels of the multi-channel audio data, the channel setting apparatus rearranges the channels of the multi-channel audio data.

In operation 812, the channel setting apparatus stores the channel setting information generated in the operation 810.

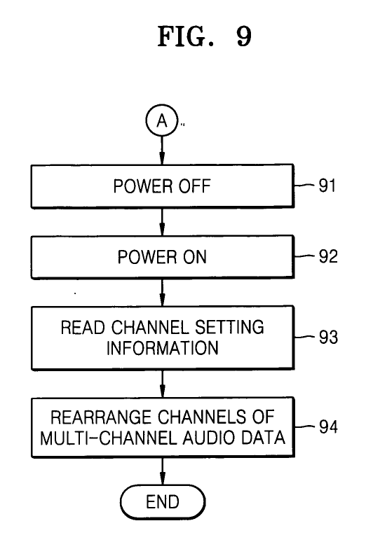

FIG. 9 is a flowchart of a channel setting method following the channel setting method shown in FIG. 8.

Referring to FIG. 9, the channel setting method following the channel setting method shown in FIG. 8 includes the following operations. Like the channel setting method shown in FIG. 8, the operations forming the channel setting method are processed in a series of time steps within the channel setting apparatus shown in FIGS. 3 and 4.

In operation 91, the power of a system on which the channel setting apparatus is mounted is turned off.

In operation 92, the power of the system on which the channel setting apparatus is mounted is turned on.

In operation 93, the channel setting apparatus reads the channel setting information stored in the operation 811.

In operation 94, the channel setting apparatus rearranges the channels of the multi-channel audio data according to the channel setting information read in the operation 93.

The exemplary embodiments of the present invention described above can be written as computer programs and can be implemented in general-use digital computers that execute the programs using a computer readable recording medium. Also, the data structure used in the exemplary embodiments of the present invention described above can be recorded on a computer readable recording medium through a variety of ways.

Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet).

While the present invention has been particularly shown and described with reference to exemplary embodiments thereof, it will be understood by those of ordinary skill in the art that various changes in form and details may be made therein without departing from the spirit and scope of the present invention as defined by the following claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

According to the present invention, the channels of multi-channel audio data can be flexibly set. By doing so, terminals of the output panel of the audio system and speakers can be connected arbitrarily according to convenience of a user and channels of multi-channel audio data can be set appropriately to the connection status.

Furthermore, according to the present invention, when multi- channel audio data is reproduced by using a digital TV or a DVD player, users can easily change the channels of the multi-channel audio data appropriately to the characteristics of the multi-channel audio data or to the preference of the users.

What is claimed is:

1. A method of flexibly setting channels of multi-channel audio data comprising:
based on a selection by a user, generating information indicating a correspondence relation between the channels of the multi-channel audio data and speakers installed in an arbitrary space; and
according to the generated information, rearranging the channels of the multi-channel audio data.

2. The method of claim 1, wherein the rearranging of the channels of the multi-channel audio data comprises setting the channels of the multi-channel audio data as being allocated to specific speakers.

3. The method of claim 1, further comprising:
extracting audio data corresponding to any one channel of the multi-channel audio data; and
outputting the extracted audio data to the speakers sequentially,
wherein the selection by the user is based on the user recognizing the extracted audio data output to the speakers.

4. The method of claim 1, further comprising:
storing the information,
wherein in the rearranging of the channels, the channels of the multi-channel audio data are rearranged according to the stored information.

5. The method of claim 1, wherein the multi-channel audio data is multi-channel audio data stored in respective channel areas of a predetermined buffer.

6. The method of claim 1, wherein the multi-channel audio data is serial audio data divided into respective channels.

7. The method of claim 1, wherein the multi-channel audio data is analog multi-channel audio data.

8. An apparatus for flexibly setting channels of multi-channel audio data comprising:
a user interface which generates information indicating a correspondence relation between the channels of the multi-channel audio data and speakers installed in an arbitrary space, based on selection by a user; and
a channel rearrangement unit which rearranges the channels of the multi-channel audio data according to the generated information.

9. The apparatus of claim 8, wherein the rearrangement unit rearranges the channels of the multi-channel audio data by setting the channels of the multi-channel audio data as being allocated to specific speakers.

10. The apparatus of claim 8, wherein the user interface extracts audio data corresponding to any one channel of the multi-channel audio data, and controls the extracted audio data to be output to the speakers sequentially, and wherein the selection by the user is based on the user recognizing the extracted audio data output to the speakers.

11. The apparatus of claim 8, further comprising:
a storage unit which stores the information,
wherein the channel rearrangement unit rearranges the channels of the multi-channel audio data according to the stored information.

12. The apparatus of claim 8, wherein the multi-channel audio data is multi-channel audio data stored in respective channel areas of a predetermined buffer.

13. The apparatus of claim 8, wherein the multi-channel audio data is serial audio data divided into respective channels.

14. The apparatus of claim 8, wherein the multi-channel audio data is analog multi-channel audio data.

15. A computer readable recording medium having embodied thereon a computer program for executing a method of flexibly setting channels of multi-channel audio data, wherein the method comprises:
based on a selection by a user, generating information indicating a correspondence relation between the channels of the multi-channel audio data and speakers installed in an arbitrary space; and
according to the generated information, rearranging the channels of the multi-channel audio data.
